(19) United States
(12) Patent Application Publication
(10) Pub. No.: US 2026/0244668 A1
(43) Pub. Date: Aug. 20, 2026

(54) TEXT CHUNKING USING CONTEXT DISRUPTION

(71) Applicant: Dell Products L.P., Round Rock, TX (US)

(72) Inventors: Claudio Romero, Rio de Janeiro (BR); Renam Castro da Silva, São José dos Campos (BR); Renan Carlos de Faria, São Paulo (BR)

(21) Appl. No.: 19/057,149

(22) Filed: Feb. 19, 2025

(51) Int. Cl. G06F 16/334

(52) U.S. Cl. CPC G06F 16/3346

(57) ABSTRACT

Chunking text in generative artificial intelligence (GenAI) systems including retrieval augmented generation (RAG) system. When ingesting sources into a RAG, the textual data extracted from the sources is chunked or split. A chunking operation chunks or splits the textual data at locations where the predictability or probability of a text piece does not benefit from contextual information provided by prior or contextual pieces of text. This results in more coherent chunks and improves the performance of the Gen AI system.

Embodiments disclosed herein generally relate to generative artificial intelligence (GenAI), which may include large language models (LLMs) and/or retrieval augmented generation (RAG). More particularly, at least some embodiments relate to systems, hardware, software, computer-readable media, and methods for chunking text for RAG systems.

### BACKGROUND

RAG is often employed in GenAI. RAG systems are built upon information retrieval and LLM technologies. LLMs technologies bring powerful conditional probability modeling capability and parametric knowledge that underpin their ability to cope with natural language intricacies. Information retrieval technologies, such as RAG systems, help overcome the static nature of the parametric knowledge of LLMs and supplement LLMs with additional data, which improves the ability of LLMs to correctly answer questions posed by users.

GenAI systems such as RAG systems rely on the availability of data in a suitable format. As a result, data must be ingested into a RAG system. Ingesting data essentially transforms raw data into data having an appropriate format suitable for LLM consumption. Upon user request, the RAG system quickly fetches pertinent content in the form of retrieval results. These results are used in generating the LLM's response to the user's question.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a RAG system that includes context-disruption-based splitting or chunking;

FIG. 2 discloses aspects of an example method for chunking or splitting textual data;

FIG. 3A discloses aspects of determining a probability for a current text piece;

FIG. 3B discloses additional aspects of determining probabilities assigned to tokens (e.g., words) in a current text piece and to the current text piece as a whole;

FIG. 3C discloses aspects of determining probabilities assigned to tokens in a current text piece in a manner that accounts for context;

FIGS. 4A-4C illustrates a comparison of chunking textual data using fixed size chunking and chunking based on a probability disruption evaluation; and

FIG. 5 discloses aspects of a computing device, system, or entity.

### DETAILED DESCRIPTION OF SOME EXAMPLE EMBODIMENTS

Embodiments disclosed herein generally relate to GenAI, which may include RAG systems. More particularly, at least some embodiments relate to systems, hardware, software, computer-readable media, and methods for ingesting data into a RAG system and more particularly to chunking text being ingested into the RAG system.

RAG systems provide flexibility to LLM-based applications by providing an LLM with access to sources on which the LLM may not have been trained or that may not be available to the LLM. A RAG system may improve the abilities of an LLM by providing the LLM with access to additional data sources. To be used, the raw data is ingested into the RAG system. Ingesting the raw data may include transforming the raw data into a suitable format. The process of ingesting data for consumption by an LLM includes splitting the text into chunks and generating embeddings of the chunks. The embeddings can be semantically compared to embeddings of a user's request or other prompt context.

More specifically, ingesting data from diverse sources and formats includes extracting textual data from the raw data sources, splitting the textual data into manageable text pieces or chunks, embedding the chunks and storing the embeddings to data systems such as vector and/or graph databases.

Embodiments of the invention relate to chunking strategies employed for splitting textual data during, in one example, the ingestion process. Conventional chunking strategies tend to introduce discontinuity by unintentionally splitting semantically coherent text units. Ingesting incoherent data may lead to inaccurate retrieval results. As a result, the contextualized data provided to the LLM for providing grounded responses may be less than optimal.

Embodiments of the invention relate to splitting textual data at points or locations where a predictability of a piece of text does not benefit from the contextual information provided by prior pieces of text. In one example, if knowledge of previous pieces of text reduces an uncertainty of a current piece of text, the current piece of text and previous pieces of text are likely related and should be kept together from a chunking or splitting perspective. If knowledge of the previous pieces of text does not reduce the uncertainty of the current text, the current piece of text and previous pieces of text are likely unrelated or less related and can separated or split apart from a chunking or splitting perspective. Embodiments of the invention may use the conditional probability capabilities of an LLM to perform/determine the required calculations or probabilities. In some examples, to reduce computation burdens, smaller LLMs may be used.

In some examples, textual data may be split into chunks not longer than a maximum number of tokens. However, this strategy is prone to creating splits or separation points at locations that semantically separate coherent text units. This concern is often addressed by employing a sematic chunking strategy. A semantic chunking strategy may measure the similarity of sentences in an embedding domain and keep sentences whose embedding distances are within a given threshold together. However, setting the proper threshold is difficult and subject to errors. In another example, a proposition model may rewrite text chunks in a more concise and self-contained manner. The proposition model, however, still needs a way to break down or split or chunk the text into text pieces.

Embodiments of the invention split an input text into chunks by identifying points where knowledge of previous pieces of text does not reduce the uncertainty as estimated by an LLM. Embodiments of the invention relate to splitting textual data into chunks using context disruption. In one example, context disruption relates to whether previous pieces of text impact the uncertainty of a current piece of text. Thus, if two (or more) text pieces are related, they should be kept together from a chunking perspective. If two (or more) text pieces are not related, there is a context disruption, and the pieces can be chunked at that location such that the two text pieces are associated to different chunks. Textual data can be split or chunked based on detecting locations at which context disruption is likely. Embodiments of the invention thus relate to a text splitter or text chunker, which may be pluggable and used with other techniques or strategies such as a proposition model and/or fixed-size chunking.

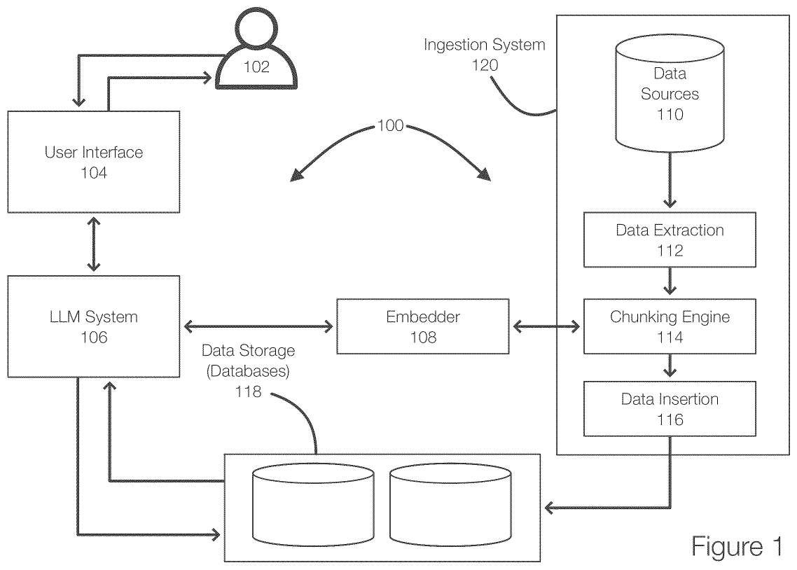

FIG. 1 discloses aspects of a GenAI system such as a RAG system. In FIG. 1, the GenAI system 100 include an LLM system 106, which includes an LLM. Via a user interface 104, a user 102 may enter a prompt (e.g., a question) that is input to the LLM system 106. The LLM system 106 may access an embedder 108 to generate an embedding for the prompt (and/or associated context). The LLM system 106 may compare the prompt embedding with embeddings stored in databases 118. The closest embeddings (e.g., based on cosine or Euclidean distances) are used by the LLM system 106 to generate a response that is provided to the user 102 in the user interface 104. Thus, the response is generated using sources or data that are most similar to the user prompt in one example.

FIG. 1 further illustrates an ingestion system 120 that is configured to ingest raw data from data sources 110 into the databases 118. The data sources 110 may store raw data (e.g., documents, standards, other data) in various formats (e.g., docx, pdf, jpg). Initially, the ingestion system 120 may perform data extraction 112 to generate textual data (e.g., text). Data extraction 112 may include extracting textual data from the data sources using various extraction mechanisms for the various types of sources.

Once the textual data is generated, a chunking engine 114 receives the textual data as input and generates chunks. The chunking engine 114 may also be configured to access the embedder 108 to generate embeddings of the chunks generated by the chunking engine 114. Once the embeddings are generated, the embeddings are inserted into the databases 118 and can be used by the LLM system 106 to generate responses to user prompts or questions.

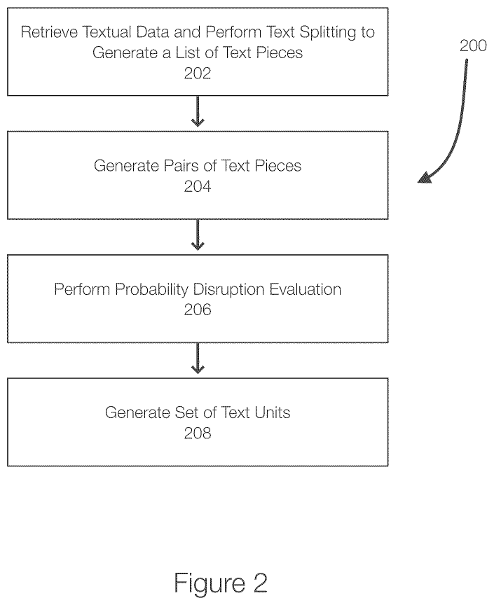

FIG. 2 discloses aspects of a method for splitting or chunking textual data. The method 200 may include, by way of example only, two splitting or chunking operations. Initially, the textual data is split into text pieces, which may include retrieving 202 textual data and generating text pieces or a list of text pieces. Initially, the textual data may be split using any reasonable delimiter applicable to the application. For example, because a context disruption is likely to happen at a full stop (e.g., a period), one choice for splitting natural language textual data would be a full stop “.”. In one example, the choice of the delimiter defines the granularity at which context disruption is evaluated in embodiments of the invention, which may impact computation cost and requirements. Another delimiter for splitting text may be newlines “\n”. In addition, delimiters such as “\n” and “.” can be combined when initially splitting 202 the textual data. This process generates a list of text pieces.

The method 200 also includes generating 204 pairs of text pieces. In one example, (t^{ctx}, t^{cur}) represents a pair of text pieces. In this notation, t^{cur} is a current text piece and t^{ctx} is the previous text piece (context). For example, if the text pieces are pieces (1, 2, 3, 4, 5), the text pairs may be [(empty,1), (1,2), (2,3), (3,4), (4,5) In addition, a text unit (TU) is defined to be composed of a set of text pieces and a set S denotes a set of all text units. Processing the text pairs may result in a set of text units. Each text unit may include one or more text pieces.

When generating the pairs of text pieces, an initialization operation is performed such that:

$$set S = \{ ∅ \} and TU = \{ {t}_{1}^{CUT} \} .$$

When generating 204 pairs of text pieces, the pairs are generated, in one example, by taking consecutive samples from the list of text pieces. For example,

$$( {t}_{i}^{ctx} , {t}_{i}^{cur} )$$

denotes a pair of text pieces. In this example,

$${t}_{i}^{cur}$$

is ith current text piece and

$${t}_{i}^{ctx}$$

as the ith context text piece preceding

$${t}_{i}^{cur} .$$

in this example, a text piece is represented in bold to indicate that the text piece is a list of words or tokens (e.g., a token vector). For the first pair of text pieces the context text piece is empty, that is

$${t}_{i}^{ctx} = ∅ .$$

This generates a list of pairs as follows:

$$\{ ( ∅ , {t}_{1}^{cur} ) ; ( {t}_{2}^{ctx} , {t}_{2}^{cur} ) ; … , ; ( {t}_{n}^{ctx} , {t}_{n}^{cur} ) \} .$$

After the set of pairs of text pieces is generated, a probability disruption evaluation is performed 206. For each pair

$$( {t}_{i}^{ctx} , {t}_{i}^{cur} )$$

of text pieces, the method 200 determines whether having access to context text (the text in the context text piece) reduces the uncertainty of the current text (text in the current text piece) with respect to not having access to the context text. In one example, the probability assigned by an LLM to the current text piece with context text and the probability assigned by the LLM to the current text piece without the context text are determined.

More specifically in one example, an autoregressive feature of a decoder in a transformer model may be used to compute the probability assigned by the model. In one example, a current text piece may include n tokens. A token, by way of example, may be a word, a part of a word, or the like. When determining the probability of a current text piece, the model may produce a probability mass function over a dictionary of tokens in an autoregressive manner. At each step, the probability assigned by the model changes as new data becomes available. Thus, when determining the probability of the current text piece, the probability determined by the model is conditioned on past data.

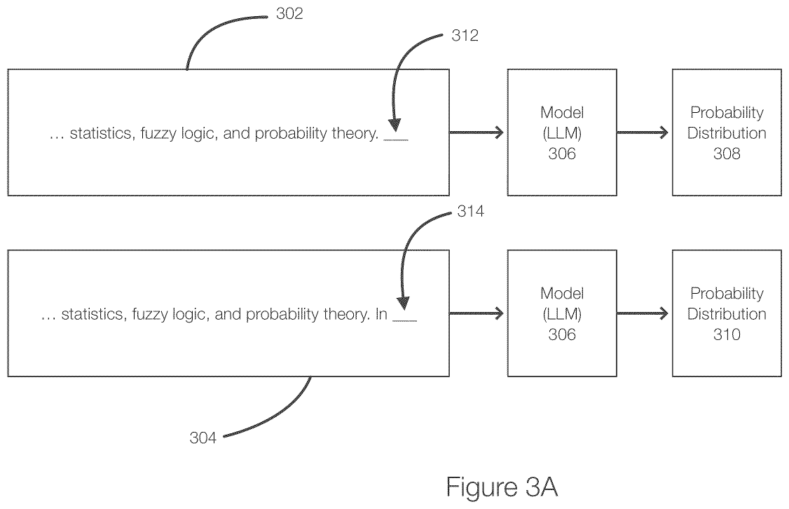

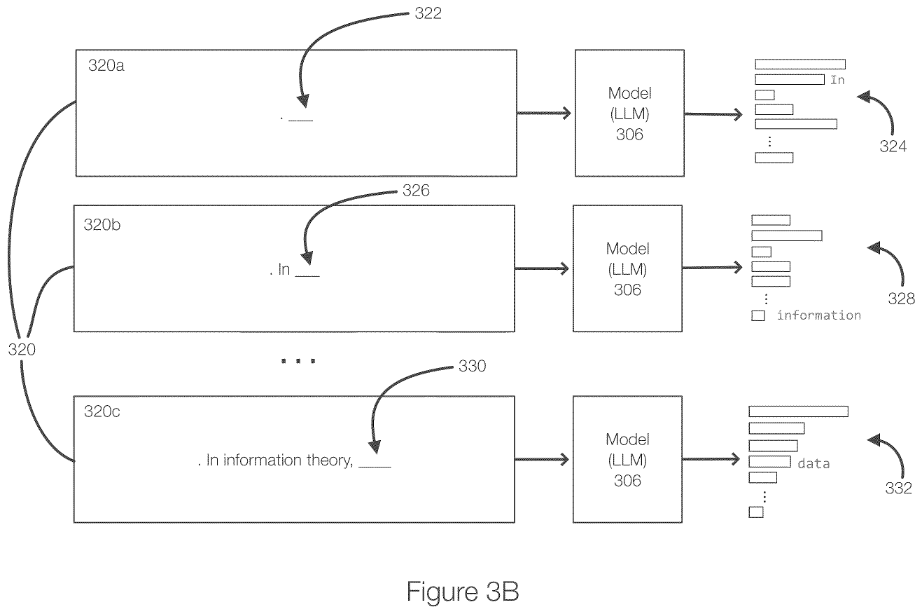

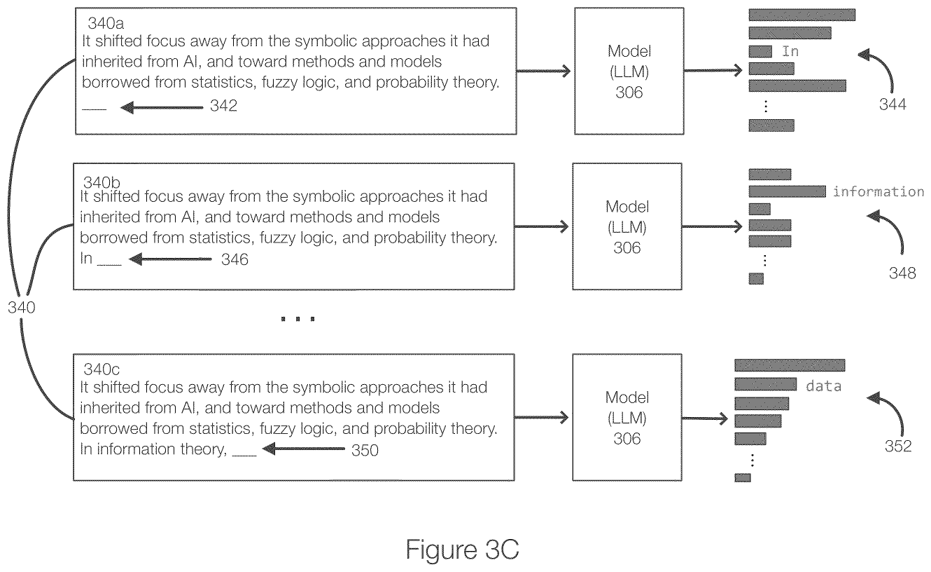

FIG. 3A discloses aspects of determining a probability for a current text piece, which may include determining a probability for a next word/token in a current text piece. FIG. 3A illustrates a text piece 302 that includes tokens (e.g., words in one example). The model 306 is determining a probability distribution 308 for the next word 312, which is based on text prior to the next word 312 in the text piece 302. In other words, the model is generating a probability distribution 308 for the word 312. Because the word 312 is actually known from the textual data, the probability of the actual word may be determined from the probability distribution 308. More specifically, the probabilities for the next word 312 is based, in part, on prior text of “ . . . statistics, fuzzy logic, and probability theory.” In this example, the next word 312 of the text piece 302 is already known, but this example illustrates or determines a probability distribution 308. As illustrated in the text piece 304 (which is the same text piece 302 but for a different token or word), a probability distribution 310 for the word (token) 314 is generated or determined.

The model 306 may use the autoregressive and probability factorization properties to assign probabilities. When the model does not have access to the context, the probability may be defined as:

$$p ( {t}_{i}^{cur} \vert context = ∅ ) = {\prod }_{j} p ( {t}_{j}^{cur} \vert {t}_{< j} ) .$$

In this example, tⱼ is jth token in the current text piece (i is omitted to avoid cluttering the notation), and t_{<j} are tokens before the current token in the current text piece.

FIG. 3B discloses additional aspects of determining probabilities assigned to tokens (e.g., words) in a current text piece. FIG. 3B illustrates a current text piece 320 (only portions of the actual text piece are illustrated) and illustrates determining probability distributions for tokens 322, 326, and 330 at instances 320a, 320b, and 320c, respectively.

In the instance 320a, the model 306 generations a probability distribution 324 for the next token 322 (which is known to be “In”) with only the “.” as context. In this example, the probability assigned to “In” is collected and stored.

In the instance 320b, the word “In” is appended to the “.” before estimating the next token 326. In this example, “information” is the next token 326 and the probability of “information” from the probability distribution 328 is collected and stored. The instance 320c illustrates that additional tokens have been appended and that the probability for the next token 330 is determined from the probability distribution 332 and stored. This process is performed for the tokens in the text piece 320. Thus, a probability can be determined for the text piece 320 and at each token of the text piece 320.

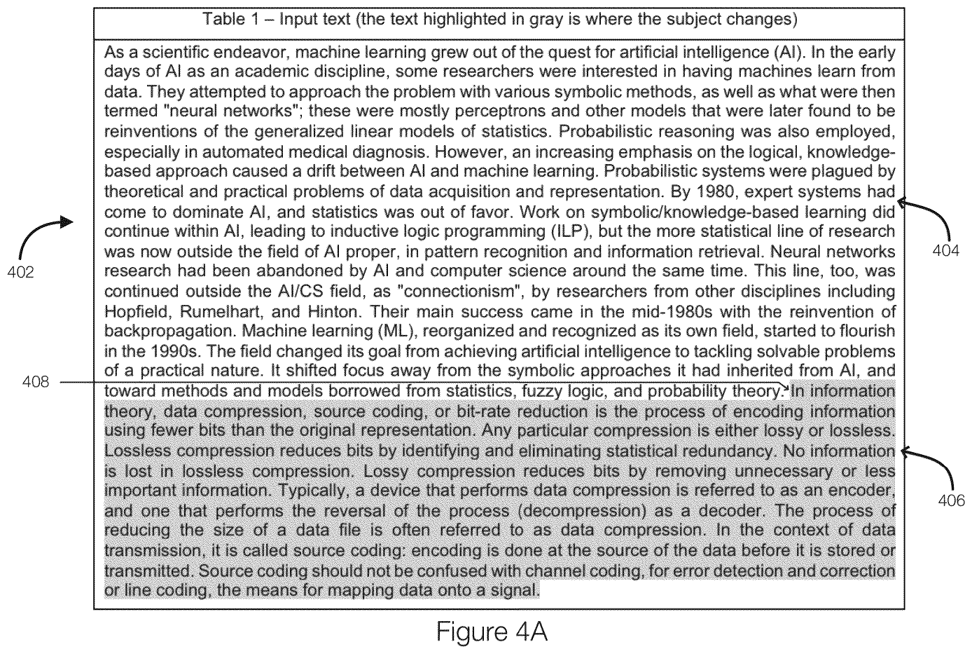

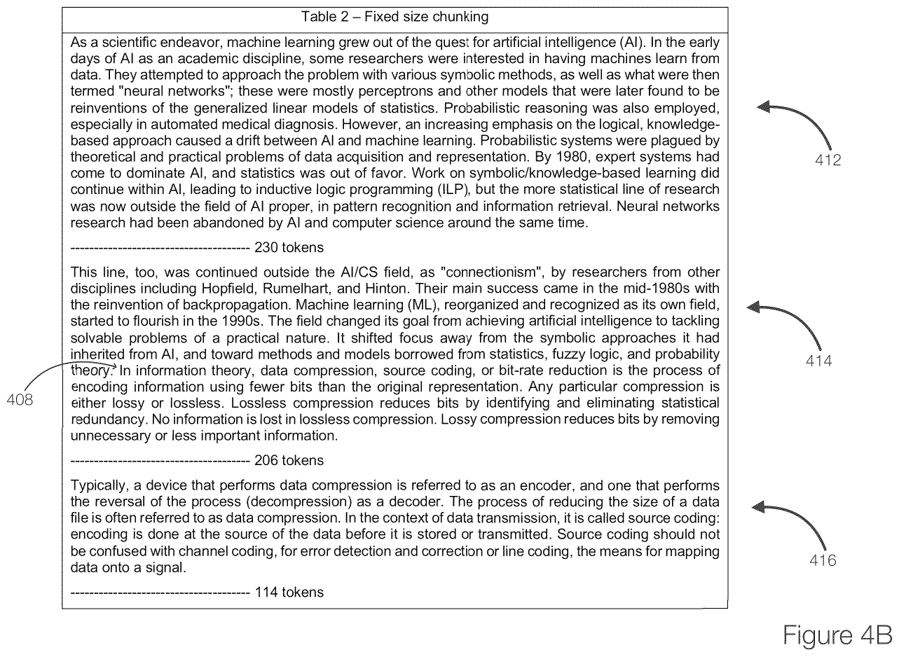

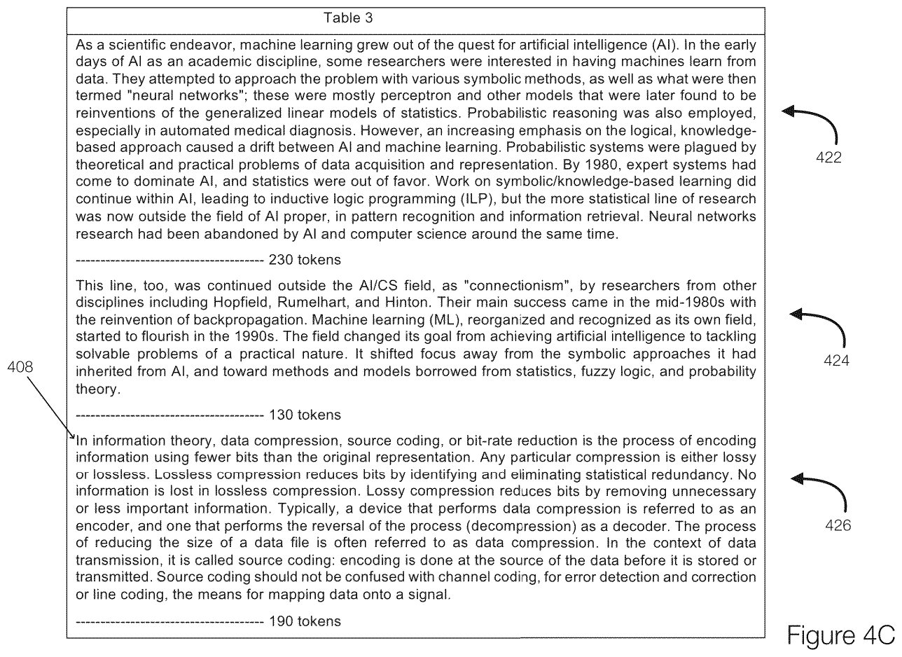

FIG. 3C discloses aspects of determining probabilities assigned to tokens in a current text piece in a manner that accounts for context. FIG. 4C illustrates textual content 340 that includes a context text piece (e.g., “It shifted focus away from the symbolic approaches it had inherited from AI, and toward methods and models borrowed from statistics, fuzzy logic, and probability theory” and a current text piece that starts, in this example, with the “.”.

In this example in the instance 340a, a probability distribution 344 is determined for the next token 342 based on both the current text piece and the context text piece. Similarly, in the instances 340b and 340c, probability distributions 348 and 352 are determined, respectively, for the next tokens 346 and 350.

More specifically, the probability assigned by the model 306 conditioned on the context text piece is:

$$p ( {t}_{i}^{c u r} \vert context = {t}_{i}^{ctx} ) = {\prod }_{j} p ( {t}_{j}^{c u r} \vert {t}_{< j} , {t}_{i}^{ctx} ) .$$

Returning to FIG. 2, when performing 206 a probability disruption evaluation, the model (e.g., the model 306) may assign a probability to the current text piece t_{cur} without considering any preceding context as:

$$p ( {t}_{i}^{c u r} \vert context = ∅ ) .$$

Next, the model may assign a second probability to the current text piece t_{cur} considering the preceding context text t_{ctx}

$$p ( {t}_{i}^{c u r} \vert context = {t}_{n}^{ctx} ) .$$

If

$$f [ p ( {t}_{i}^{c u r} \vert context = {t}_{n}^{ctx} ) ] < f [ p ( {t}_{i}^{c u r} \vert context = ∅ ) ] ,$$

then the current text

$${t}_{i}^{c u r}$$

is appended to a current text unit TU. In this example, ƒ is a function of probability (e.g., self-information function).

In this example, embodiments of the invention determine whether knowing the context reduces the self-information with regard to or in comparison to not knowing the context.

If

$$f [ p ( {t}_{i}^{c u r} \vert context = {t}_{n}^{ctx} ) ] < f [ p ( {t}_{i}^{c u r} \vert context = ∅ ) ]$$

is not satisfied, the current text unit TU is added to the set S of all text units, a new text unit is created empty, and the current text piece

$${t}_{i}^{c u r}$$

is added to the new text unit. IT this condition does not hold, having access to the context text piece does not help to reduce the self-information and this is an indication that the two text pieces are somewhat unrelated and may be split.

More specifically in one example, the function ƒ may be a Shannon self-information function. Once a first probability is assigned by the model to the current text piece

$${t}_{i}^{c u r}$$

conditioned solely on current text piece and a second probability is assigned by the model to the current text piece

$${t}_{i}^{c u r}$$

conditioned on the context text and current text piece, a function such as the Shannon self-information may be performed to decide whether to split the text. An example function is:

$$self - info [ p ( {t}_{i}^{c u r} \vert context = {t}_{i}^{ctx} ) ] / N < self - info [ p ( {t}_{i}^{c u r} \vert context = ∅ ) ] / N - \frac{1}{N} {\sum }_{j} log p ( {t}_{j}^{c u r} \vert {t}_{< j} , {t}_{i}^{ctx} ) < - \frac{1}{N} {\sum }_{j} log p ( {t}_{j}^{c u r} \vert {t}_{< j} ) .$$

In this example, tⱼ is jth token in the current text piece (i is omitted to avoid cluttering the notation). N is the number of tokens in the current text piece.

If the condition in the equation above does not hold, having access to the context text piece does not help to reduce the self-information. This is an indication that the text pieces are somewhat unrelated and can be broken down or split or chunked.

A more stringent alternative criterion is to apply the criterion above in both directions. In this example, the probability assigned by the model for the context text piece

$${t}_{i}^{ctx}$$

with and without considering the current text piece

$${t}_{i}^{c u r}$$

may be determined. In this example, splitting is done when the self-information, taking into account the context, is not less than the self-information considering solely the current text.

When a context disruption is detected (e.g., the condition does not hold), a new text unit may be started. Based on detecting or identifying context disruptions, the text pieces are effectively chunked—each text unit is a chunk in one example.

The probability disruption evaluation is performed for each pair of text pieces. After all of the pairs of text pieces have been evaluated, a set of text units is generated 208 as follows:

$$S = \{ T {U}_{1} , … , {TU}_{m} \} .$$

The process of performing 206 the probability distribution evaluation and generating 208 the set of text units is an example of a second splitting operation. In effect, the text pieces that were previously split using, for example, delimiters, are split or chunked into text units. Forming a text unit may aggregate or combine one or more text pieces. Generating text units based on a context or probability disruption evaluation generates more coherent text units that a less likely to contain disrupted contexts. This increases the likelihood of producing useful document chunks for GenAI systems, including RAG systems. In some examples, the text units may be broken down to meet size constraints (e.g., some LLMs have a token limit) or combined without other approaches to chunking textual data.

Embodiments of the invention may employ a smaller LLM (e.g., fewer parameters, less computational complexity than larger LLMs). More specifically, embodiments of the invention may use small LLM to estimate optimal splitting points for the generation of coherent text chunks for RAG systems, without the risk of hallucinations from the LLM rewriting the chunks. In addition, chunks are generated in a manner that considers a variable context. Also, the previous context can be a moving window of previous text pieces and may be reset once a chunk is created.

In one example, embodiments of the invention may manage computation costs for computing the self-information of a current text piece

$${t}_{i}^{c u r} .$$

In one example, the user-defined parameter kₐ that controls how many tokens the LLM may use to estimate the probability. Instead of running the LLM for all tokens of the current text piece, the LLM is run only up to the kₐth token as follows:

$$\frac{1}{{k}_{a}} {\sum }_{j}^{{k}_{a}} - log p ( {t}_{j}^{c u r} \vert {t}_{< j} , {t}_{i}^{ctx} ) < \frac{1}{{k}_{a}} {\sum }_{j}^{{k}_{a}} - log p ( {t}_{j}^{c u r} \vert {t}_{< j} ) .$$

In one example, to prevent a context text piece from inadvertently changing the probability mass function over the token dictionary at each language model inference step, the probability assigned by the model to the token may be considered only if the probability is within the top-kₕ highest probable tokens.

### Experiments and Results

FIGS. 4A-4C illustrates a comparison of chunking textual data using fixed size chunking and chunking based on a probability disruption evaluation. More specifically, FIG. 4A illustrates an example of textual data 402. FIG. 4B discloses aspects of splitting the textual data 402 using a fixed size chunking strategy and FIG. 4C discloses aspects of splitting the textual data in a probability context disruption manner. In this example, the textual data 402 includes a first text 404 and a second text 406 (in gray) in the textual data 402. A subject change 408 occurs between the first text 404 and the second text 406

The fixed sized chunking strategy, applied to the textual data 402 in FIGS. 4B, resulted in chunks 412, 414, and 416. FIG. 4B illustrates that the location at which the subject changes in the textual data 402 (the subject change 408) does not correspond to a start of a new chunk in FIG. 4B. Rather, the subject change 408 is present in the chunk 414. This indicates that the chunk 414, at least, may have less coherency and that fixed size chunking does not account for context disruptions.

FIG. 4C illustrates chunks 422, 424, and 426 generated from the textual data 402 in accordance with embodiments of the invention. The context disruption was detected and the text piece beginning with the subject change 408 is at the beginning of the chunk 426 (or a different text unit from the previous text pieces). The chunk 422 may have been limited by size. Thus, the chunks 422, 424, and 426 have higher coherence compared to the chunk 414 and may result in an improved response in GenAI systems including RAG systems.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, LLM related RAG operations, text ingestion operations, chunking operations, probability related operations for chunking textual data, and the like. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation May comprise, or at least involve the use of, hardware and/or software. An image of a VM may take the form of a .VMX file and one or more .VMDK files (VM hard disks) for example.

As used herein, the terms ‘object’ and ‘data’ are intended to be broad in scope. Example embodiments are applicable to any system capable of storing and handling various types of objects or data, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method, comprising: generating a list of text pieces from textual data that is generated from one or more sources, generating pairs of text pieces from the list of text pieces, wherein each of the pairs includes a context text piece and a current text piece, for each pair of text pieces: determining a first probability by a model of the current text piece in the pair of text pieces without considering the context text piece, determining a second probability by the mode of the current text piece that considers the context text piece, performing a probability function using the first probability and the second probability to determine whether the context text piece reduces self-information of the current text piece compared to not knowing the context text piece, and appending the current text piece to a current text unit when the probability function is satisfied, wherein a set of text units constitutes chunks for a generative artificial intelligence system.

Embodiment 2. The method of embodiment 1, wherein the context text piece for a first pair of the pairs of text pieces is empty.

Embodiment 3. The method of embodiment 1 and/or 2, wherein the current text piece in a pair of the text pieces is the context text piece in a next pair of the text pieces.

Embodiment 4. The method of embodiment 1, 2, and/or 3, wherein each of the text units in the set of text units include one or more of the text pieces.

Embodiment 5. The method of embodiment 1, 2, 3, and/or 4, further comprising, determining a probability for each of the tokens in the current text piece.

Embodiment 6. The method of embodiment 1, 2, 3, 4, and/or 5, wherein the probability function comprises a Shannon self-information function to determine whether to include the current text piece in the current text unit.

Embodiment 7. The method of embodiment 1, 2, 3, 4, 5, and/or 6, wherein the current text piece is included in a new text unit when the probability function fails.

Embodiment 8. The method of embodiment 1, 2, 3, 4, 5, 6, and/or 7, further comprising controlling computation requirements using a first parameter that controls how many tokens are used to estimate the first probability and the second probability.

Embodiment 9. The method of embodiment 1, 2, 3, 4, 5, 6, 7, and/or 8, further comprising preventing the context text piece from changing a probability mass function over a token dictionary by considering the first probability and/or the second probability only when within a top k highest probable tokens.

Embodiment 10. The method of embodiment 1, 2, 3, 4, 5, 6, 7, 8, and/or 9, wherein the text pieces are generated from the textual data by splitting the textual data using delimiters.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

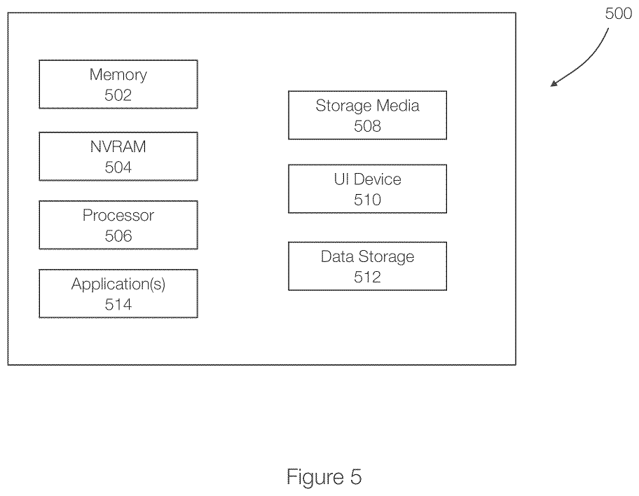

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
generating a list of text pieces from textual data that is generated from one or more sources;
generating pairs of text pieces from the list of text pieces, wherein each of the pairs includes a context text piece and a current text piece;
for each pair of text pieces:
determining a first probability by a model of the current text piece in the pair of text pieces without considering the context text piece;
determining a second probability by the model of the current text piece that considers the context text piece;
performing a probability function using the first probability and the second probability to determine whether the context text piece reduces self-information of the current text piece compared to not knowing the context text piece; and
appending the current text piece to a current text unit when the probability function is satisfied,
wherein a set of text units constitutes chunks for a generative artificial intelligence system.

2. The method of claim 1, wherein the context text piece for a first pair of the pairs of text pieces is empty.

3. The method of claim 2, wherein the current text piece in a pair of the text pieces is the context text piece in a next pair of the text pieces.

4. The method of claim 1, wherein each of the text units in the set of text units include one or more of the text pieces.

5. The method of claim 1, further comprising, determining a probability for each of the tokens in the current text piece.

6. The method of claim 1, wherein the probability function comprises a Shannon self-information function to determine whether to include the current text piece in the current text unit.

7. The method of claim 1, wherein the current text piece is included in a new text unit when the probability function fails.

8. The method of claim 1, further comprising controlling computation requirements using a first parameter that controls how many tokens are used to estimate the first probability and the second probability.

9. The method of claim 1, further comprising preventing the context text piece from changing a probability mass function over a token dictionary by considering the first probability and/or the second probability only when within a top k highest probable tokens.

10. The method of claim 1, wherein the text pieces are generated from the textual data by splitting the textual data using delimiters.

11. A non-transitory storage medium having stored therein instructions that are executable by one or more hardware processors to perform operations comprising:
generating a list of text pieces from textual data that is generated from one or more sources;
generating pairs of text pieces from the list of text pieces, wherein each of the pairs includes a context text piece and a current text piece;
for each pair of text pieces:
determining a first probability by a model of the current text piece in the pair of text pieces without considering the context text piece;
determining a second probability by the mode of the current text piece that considers the context text piece;
performing a probability function using the first probability and the second probability to determine whether the context text piece reduces self-information of the current text piece compared to not knowing the context text piece; and
appending the current text piece to a current text unit when the probability function is satisfied,
wherein a set of text units constitutes chunks for a generative artificial intelligence system.

12. The non-transitory storage medium of claim 11, wherein the context text piece for a first pair of the pairs of text pieces is empty.

13. The non-transitory storage medium of claim 12, wherein the current text piece in a pair of the text pieces is the context text piece in a next pair of the text pieces.

14. The non-transitory storage medium of claim 11, wherein each of the text units in the set of text units include one or more of the text pieces.

15. The non-transitory storage medium of claim 11, further comprising, determining a probability for each of the tokens in the current text piece.

16. The non-transitory storage medium of claim 11, wherein the probability function comprises a Shannon self-information function to determine whether to include the current text piece in the current text unit.

17. The non-transitory storage medium claim 11, wherein the current text piece is included in a new text unit when the probability function fails.

18. The non-transitory storage medium of claim 11, further comprising controlling computation requirements using a first parameter that controls how many tokens are used to estimate the first probability and the second probability.

19. The non-transitory storage medium of claim 11, further comprising preventing the context text piece from changing a probability mass function over a token dictionary by considering the first probability and/or the second probability only when within a top k highest probable tokens.

20. The non-transitory storage medium of claim 11, wherein the text pieces are generated from the textual data by splitting the textual data using delimiters.
